(19) United States
(12) Patent Application Publication
(10) Pub. No.: US 2014/0298321 A1
(43) Pub. Date: Oct. 2, 2014

(54) INSTALLATION CONTROL METHOD AND INSTALLATION CONTROL APPARATUS

(71) Applicant: FUJITSU LIMITED, Kawasaki-shi (JP)

(72) Inventors: Koji Morino, Fuji (JP); Yoshitaka Higuchi, Numazu (JP); Noboru Amano, Susono (JP); Kiyomi Kimura, Fuji (JP); Hideo Abotani, Numazu (JP); Eiji Saitou, Mishima (JP)

(73) Assignee: FUJITSU LIMITED, Kawasaki-shi (JP)

(21) Appl. No.: 14/164,486

(22) Filed: Jan. 27, 2014

(30) Foreign Application Priority Data
Mar. 27, 2013 (JP) 2013-067397

(51) Int. Cl. G06F 9/445

(52) U.S. Cl. CPC G06F 8/61
USPC 717/175

(57) ABSTRACT

An installation control method executed by a computer, the installation control method includes: extracting installation information related to an install process of each of a plurality of software modules to be installed onto an apparatus; calculating a load with respect to the install process on the apparatus, in installing the plurality of software modules in each of a plurality execution sequence candidates of an install process in accordance with the installation information; and selecting an execution sequence that is executed by the apparatus, among the execution sequence candidates, in accordance with the load.

### CROSS-REFERENCE TO RELATED APPLICATION

This application is based upon and claims the benefit of priority of the prior Japanese Patent Application No. 2013-067397, filed on Mar. 27, 2013, the entire contents of which are incorporated herein by reference.

### FIELD

The embodiments discussed herein are related to a technique of controlling installation of software.

### BACKGROUND

In one of the available techniques to install multiple software modules, an installation sequence is determined in view of a dependency relationship between the software modules to be installed so that all the software modules are normally installed. Japanese Laid-open Patent Publication No. 2007-219866 discloses a technique that determines an installation sequence in view of a combination and sequence of installations to install multiple software modules so that all the number of restarts is minimized in the install process of the multiple software modules.

### SUMMARY

According to an aspect of the invention, an installation control method executed by a computer, the installation control method includes: extracting installation information related to an install process of each of a plurality of software modules to be installed onto an apparatus; calculating a load with respect to the install process on the apparatus, in installing the plurality of software modules in each of a plurality execution sequence candidates of an install process in accordance with the installation information; and selecting an execution sequence that is executed by the apparatus, among the execution sequence candidates, in accordance with the load.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration example of an installation system;

FIG. 2 illustrates an example of a hardware configuration that executes an install process;

FIG. 3 is a flowchart illustrating an example of an install process;

FIG. 4 is a table listing a data example of installation information;

FIG. 5 is a flowchart illustrating an example of a software specifying process;

FIG. 6 is a flowchart illustrating an example of an installation information collecting process;

FIG. 7 is a flowchart illustrating an example of a route table production process;

FIG. 8 is a flowchart illustrating an example of a grouping process performed in accordance with a dependency relationship;

FIG. 9 illustrates a first route table;

FIG. 10 illustrates a second route table;

FIG. 11A and FIG. 11B illustrate examples of directed graph;

FIG. 12 is a flowchart illustrating an example of an installation candidate extraction process;

FIG. 13 illustrates an example of an installation sequence candidate based on an essential relationship;

FIG. 14 is a flowchart illustrating an example of an installation cost calculation process;

FIG. 15 illustrates an example of a cost criteria table;

FIG. 16A and FIG. 16B are flowcharts illustrating an example of an installation sequence selection process;

FIG. 17 illustrates a calculation example of installation costs in a first example;

FIG. 18 illustrates an example of cost calculation results in the first example;

FIG. 19 illustrates an example of cost calculation results in a second example;

FIG. 20 illustrates an example of sorting performed in accordance with a set step count in the installation information;

FIG. 21 illustrates an example of cost calculation results in a third example; and

FIG. 22 illustrates an example of automatic learning of the installation information.

### DESCRIPTION OF EMBODIMENTS

When multiple software modules are installed, entire process time is shortened in concert with software dependency relationship.

In the related art method described above, time to restart is reduced by performing restart operations collectively. Factors that vary installation time include the number of installed pieces of software and the number of services executed when the software is installed. Minimizing the number of restarts does not necessarily lead to an optimal process time.

Some pieces of software from among multiple pieces of software may not be available at the time of installation and may then be later installed, or the installation of some pieces of software may be desirably delayed because of the high difficulty level thereof. No method has been available to select an appropriate installation sequence under such circumstances.

In one aspect, the technique disclosed in an embodiment is directed to an appropriate selection of an installation sequence of a plurality of pieces of software.

Embodiments are described in detail with reference to the accompanying drawings.

Configuration Example of Installation System

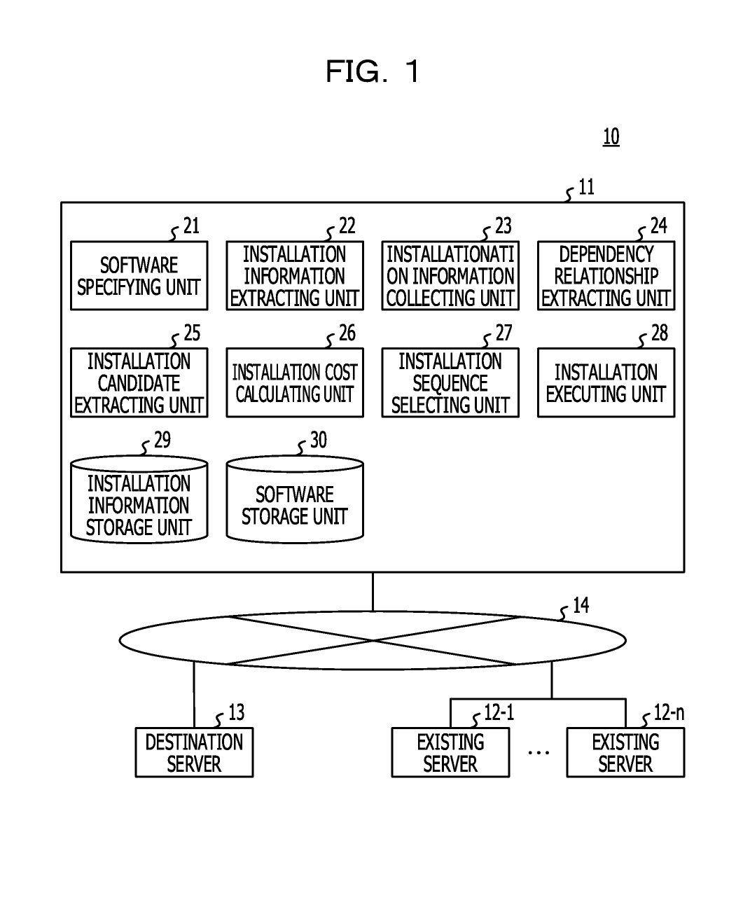

FIG. 1 is a configuration example of an installation system. The installation system 10 of FIG. 1 includes an information processing apparatus 11, a plurality of servers 12-1 through 12-n (hereinafter referred to as an “existing server 12” as appropriate), and a destination server 13. The information processing apparatus 11, the existing server 12 and the destination server 13 are interconnected in a data transmit and receive enabled state using a communication network 14, such as the Internet or a local area network (LAN).

The information processing apparatus 11 is an example of a software installation apparatus that acquires installation information obtained from the existing server 12, and manages a sequence of installations of specific software when the specific software is installed on the destination server 13. The information processing apparatuses 11 include but is not limited to a personal computer (PC), a server, a tablet terminal, and a smart phone.

The existing server 12 is an apparatus that is providing a specific service and has a variety of pieces of software installed thereon. The software respectively installed on the existing server 12-1 through the existing server 12-n is executed at specific timings or in response to instructions. The existing server 12 may transmit to the information processing apparatus 11 software information at the installation of the software thereon (such as log information).

The existing server 12 is an apparatus that has a variety of operating systems (OS's) such as Windows (registered trademark), Linux (registered trademark), and Solaris (registered trademark) installed thereon.

The destination server 13 installs one or more pieces of software as installation targets. Elements in the information processing apparatus 11 may be arranged within the destination server 13. The OS of the destination server 13 includes but is not limited to Windows.

The existing server 12 and the destination server 13 may be a computer that allows software of the embodiment to be installed thereon. The software may be acquired via a recording medium such as a compact disk ROM (CD-ROM) or digital versatile disk (DVD), or may be acquired by downloading the software from an external device connected to the communication network 14.

When an installation sequence of a plurality of pieces of software is selected, an installation sequence may be flexibly changed in the combination thereof in the embodiment. The embodiment determines the installation sequence that shortens installation time by minimizing the effect of program restart and service startup and by using parallel installation.

The word software herein refers to a description of steps and instructions that are arranged in a computer-understandable form and causes a computer to run. Data other than a computer program handled by the computer may also referred to as the software. The software may include basic software (such as OS), application software, document editing software, and spreadsheet software. Function and configuration of the information processing apparatus 11 of FIG. 1 are specifically described below.

Functional Configuration of Information Processing Apparatus

The information processing apparatus 11 of FIG. 1 includes a software specifying unit 21, an installation information extracting unit 22, an installation information collecting unit 23, a dependency relationship extracting unit 24, an installation candidate extracting unit 25, an installation cost calculating unit 26, an installation sequence selecting unit 27, an installation executing unit 28, an installation information storage unit 29 and a software storage unit 30.

The software specifying unit 21 specifies the destination server 13 as an installation destination, a type of software corresponding to a service to be performed by the destination server 13, and an installation condition accounting for a user request. The user request includes but is not limited to the setting of a difference in software delivery time, a difficulty level of software setting, and a workload distribution at installation. The process of the software specifying unit 21 may be performed from another terminal connected to the information processing apparatus 11 via the communication network 14.

The installation information extracting unit 22 extracts the installation information of each piece of software input via the software specifying unit 21 as an installation target from the installation information stored on the installation information storage unit 29. The installation information includes but is not limited to information related to an installation job of each piece of software. For example, the installation information extracted by the installation information extracting unit 22 includes but is not limited to the OS information specified by the software specifying unit 21, and a record having a software name as a key name retrieved from the installation information storage unit 29.

The installation information collecting unit 23 collects time and date of the installation of software installed on the existing server 12, and time and date of the production of an install directory that is produced at the installation of the software. The time and date of the installation and the time and date of the production of the install directory may be acquired from software management information individually managed by the existing server 12. At the installation, the installation information collecting unit 23 may acquire the installation information by causing the existing server 12 to transmit to the information processing apparatus 11 information indicating that the software has been installed.

The installation information collecting unit 23 extracts a coexistence relationship between pieces of software from the collected installation information and automatically learns the coexistence relationship of the installation information on the installation information storage unit 29. The installation information collecting unit 23 collects the information if the installation contents on the existing server 12 has been changed (such as addition or deletion of software) or if the existing server 12 is added. The installation information collecting unit 23 may also collect the information in other cases. The case that the existing server 12 is added may be the case in which the destination server 13 is recognized as the existing server 12 after the installation. In the embodiment, a more appropriate installation sequence may be selected when the installation information collecting unit 23 collects the installation information from the existing server 12 and uses the collected installation information as past record data.

The dependency relationship extracting unit 24 extracts a dependency relationship such as essential, exclusive, and coexisting relationship between pieces of software in accordance with the installation information extracted by the installation information extracting unit 22. Also, the dependency relationship extracting unit 24 produces a route table of software in accordance with the extracted coexistence relationship (a route table sorted according to the coexistence relationship, for example).

In accordance with the produced route table and the like, the dependency relationship extracting unit 24 produces graphs, such as a plurality of directed graphs including nodes and edges, with respect to the software in the essential relationship. The dependency relationship extracting unit 24 determines an installation sequence of a partial route (a partial route installation sequence) from the directed graphs produced. The route may be determined using topological sorting as a route search method. The route search method is not limited to topological sorting.

In a round-robin algorithm, the installation candidate extracting unit 25 searches for a combination of pieces of software forming each partial route while maintaining the installation sequence of the partial route obtained by the dependency relationship extracting unit 24. The installation candidate extracting unit 25 determines all the installation sequence candidates that are executable and satisfy the installation sequence of the essential relationship.

The installation cost calculating unit 26 applies a predetermined cost criteria table to the installation sequence candidate extracted by the installation candidate extracting unit 25 in order to determine an installation cost involved in the installation job of each installation sequence candidate. The costs herein include but are not limited to a load and the like on the installation job.

The installation cost calculating unit 26 calculates a cost at a location within the installation sequence of each piece of software using a criteria table of cost as overhead at the installation, and further calculates an installation cost (load involved in the installation) by summing the costs of all the software. The installation cost calculating unit 26 may calculate the installation cost corresponding to an installation condition specified on the software specifying unit 21 by the user.

The installation sequence selecting unit 27 selects the installation sequence satisfying the condition specified by the software specifying unit 21 from among the installation sequence candidates determined by the installation candidate extracting unit 25.

If the installation sequence having the shortest installation time is to be selected, the installation sequence selecting unit 27 selects the installation sequence having a minimum value of the installation cost determined by the installation cost calculating unit 26. If the installation sequence having a fixed sequence of software is to be selected, the installation sequence selecting unit 27 determines the installation sequence in which the software specified by the software specifying unit 21 is located at the specified order. For example, given software may be installed last. For example, if a plurality of sequences is specified, the installation sequence selecting unit 27 may set one in accordance with a predetermined sequence priority (for example, a candidate having a smallest value of installation cost), or may allow the user to specify one.

If the number of products to be installed is partitioned by an installation workload ratio, the installation sequence selecting unit 27 partitions the number of products to be installed at a position where a cumulative installation cost of the software determined by the installation cost calculating unit 26 becomes a specified workload ratio. Also, if the number of products to be installed is partitioned by the installation time, the installation sequence selecting unit 27 converts the installation cost of the software determined by the installation cost calculating unit 26 into real time, and then partitions the number of products to be partitioned at a location of the software that may be installed within the specified time.

If the installation sequence is to be determined in accordance with a set difficulty level, the installation sequence selecting unit 27 first sorts the software specified by the software specifying unit 21 according to a step count (difficulty level) of the installation information. The installation sequence selecting unit 27 then selects software having the set step count equal to or above the specified step count, and then selects from the selected installation sequence candidates an installation sequence in which selected pieces of the software are consecutive or almost consecutive. If a plurality of sequences is available, the installation sequence selecting unit 27 may select a candidate with a higher priority placed on one having a minimum installation cost.

The installation executing unit 28 installs the software as an installation target stored on the software storage unit 30 on the destination server 13 in accordance with the shortest installation sequence of the software calculated by the installation cost calculating unit 26 or in accordance with the installation sequence selected by the installation sequence selecting unit 27.

The installation information storage unit 29 stores the installation information of the software, including exclusive software, essential software, coexisting software, and the condition becoming an overhead during installation (restart at installation, and service startup at installation).

The software storage unit 30 stores a binary module of the software as an installation target, a program file, and the like.

The information to be stored on the installation information storage unit 29 and the software storage unit 30 is not limited to these pieces of information. For example, a criteria table at the cost calculation of the installation cost calculating unit 26 may also be stored. The installation information storage unit 29 and the software storage unit 30 may be integrally formed as part of a memory.

Hardware Configuration Example of Information Processing Apparatus

The installation process of the embodiment is implemented by installing an executing program (an install program) to cause a computer to perform a function on a general-purpose computer. A hardware configuration of a computer that implements the installation process of the embodiment is described with reference to the drawings.

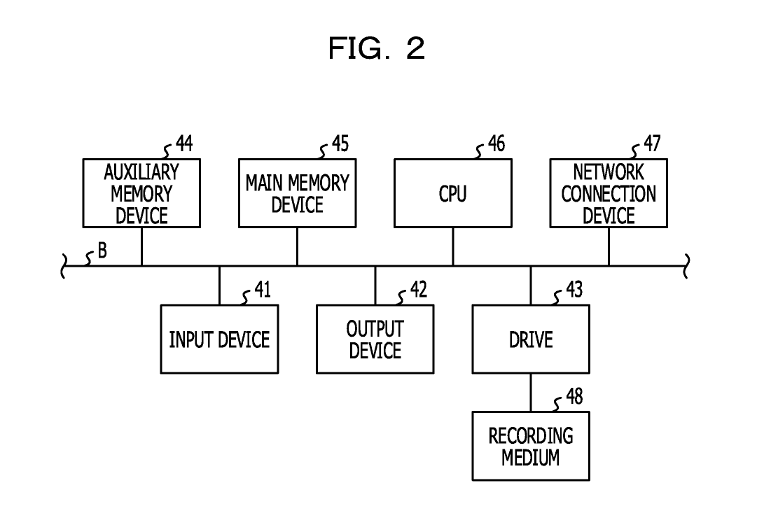

FIG. 2 illustrates an example of a hardware configuration that executes an installation process. A computer body of FIG. 2 includes an input device 41, an output device 42, a drive 43, an auxiliary memory device 44, a main memory device 45, a central processing unit (CPU) 46, and a network connection device 47. These elements are interconnected to each other via a system bus B.

The input device 41 includes a pointing device, such as a keyboard and a mouse operated by the user, and a voice input device, such as a microphone. The input device 41 receives from the user an execute instruction of a program, information for a variety of operations, information to start up the software, and other information.

The output device 42 includes a display that displays various windows and data to operate the computer that performs the process of the embodiment. The output device 42 displays the progress and results of a program under the control of a control program of the CPU 46.

The executing program to be installed on the computer in the embodiment may be provided in a recorded state on a portable recording medium 48 such as a Universal Serial Bus (USB) memory, a compact-disk read-only memory (CD-ROM), or a digital versatile disk (DVD). The recording medium 48 having the program recorded thereon is loaded on the drive 43, and the executing program stored on the recording medium 48 is installed on the auxiliary memory device 44 from the recording medium 48 via the drive 43 in response to a control signal from the CPU 46.

The auxiliary memory device 44 is a storage unit, such as a hard disk drive or a solid state drive (SSD). In response to the control signal from the CPU 46, the auxiliary memory device 44 stores the executing program in the embodiment, a control program in the computer, and other programs, and inputs and outputs the programs as appropriate. In response to the control signal from the CPU 46, the auxiliary memory device 44 reads information from a variety of information stored, and writes information thereon.

The main memory device 45 stores the executing program read from the auxiliary memory device 44 by the CPU 46. The main memory device 45 may be a read-only memory (ROM), a random-access memory (RAM), or the like. Each of the auxiliary memory device 44 and the main memory device 45 corresponds to each of the installation information storage unit 29 and the software storage unit 30.

Under the control of the control program, such as the operating system, and the executing program stored on the main memory device 45, the CPU 46 performs each process by generally controlling the computer, for example, by performing a variety of arithmetic processes and exchanging data with hardware elements. The CPU 46 may acquire a variety of information to be used in the execution of each program from the auxiliary memory device 44 and may then store execution results thereon.

More specifically, the CPU 46 performs a process corresponding to a program on the main memory device 45 by executing the program installed on the auxiliary memory device 44 in response to a program execution instruction obtained from the input device 41. For example, the CPU 46 executes an install program, thereby causing the software specifying unit 21 to enter a specified input, the installation information extracting unit 22 to extract the installation information, and the installation information collecting unit 23 to collect the installation information.

The CPU 46 executes the install program, thereby causing the dependency relationship extracting unit 24 to extract the dependency relationship between pieces of software, the installation candidate extracting unit 25 to extract the installation sequence candidates, and the installation cost calculating unit 26 to calculate the costs. The CPU 46 further executes the install program, thereby causing the installation sequence selecting unit 27 to select the installation sequence and the installation executing unit 28 to execute the software installation. The processes performed by the CPU 46 are not limited to these operations. The processes executed by the CPU 46 may be stored on the auxiliary memory device 44 as appropriate.

In response to the control signal from the CPU 46, the network connection device 47 connects the computer to a communication network and acquires the execution program, the software, set information, and other information from an external apparatus connected to the communication network. The network connection device 47 may supply to the external apparatus execution results obtained by performing the program or the execution program itself.

The hardware configuration described above may perform the installation process of the embodiment. With the program installed, a general-purpose PC or a communication terminal may easily execute the installation process of the embodiment.

Example of Installation Process

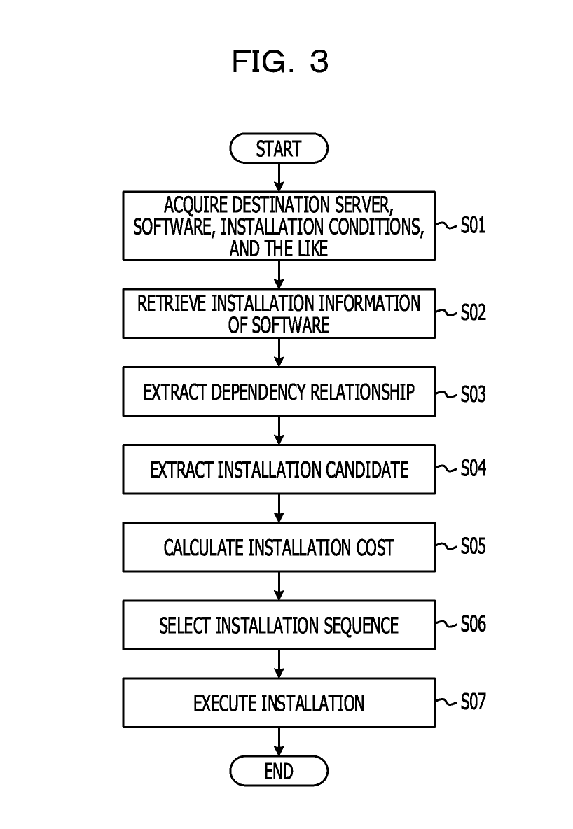

An example of the installation process of the embodiment is described with reference to flowcharts. FIG. 3 is a flowchart illustrating an example of an installation process. In the flowchart of FIG. 3, the software specifying unit 21 acquires information, about an installation destination server (apparatus), software to be installed, and an installation condition, which the user has input using the input device 41 (S01).

The installation information extracting unit 22 retrieves from the installation information storage unit 29 the installation information of each piece of software as an installation target acquired in the operation in S01 (S02).

The dependency relationship extracting unit 24 extracts the dependency relationship, such as essential, exclusive, and coexisting relationship between pieces of software in accordance with the installation information retrieved in the operation in S02 (S03). In the operation in S03, the installation information collecting unit 23 may acquire, in advance, information related to the installation of the software installed on the existing server 12, collect the dependency relationship between the pieces of software from the acquired installation information, and automatically learn the dependency relationship of the installation information on the installation information storage unit 29. Also in S03, the dependency relationship extracting unit 24 may produce a route table corresponding to the extracted dependency relationship or may produce a plurality of directed graphs including nodes and edges with respect to pieces of software in the essential relationship. Furthermore, the dependency relationship extracting unit 24 may determine the installation sequence of each partial route from the plurality of tables and graphs produced in terms of the essential relationship.

In a round-robin algorithm, the installation candidate extracting unit 25 searches for combinations of pieces of software forming each partial route while maintaining the installation sequence of the partial route acquired in the operation in S03 (S04). The installation candidate extracting unit 25 extracts all the installation sequence candidates. In the operation in S04, the installation candidate extracting unit 25 extracts all the installation sequences satisfying the installation sequence in the essential relationship.

The installation cost calculating unit 26 calculates the cost of each of the installation sequence candidates extracted in the operation in S04 in accordance with the cost criteria table of the overhead at the installation (S05).

The installation sequence selecting unit 27 selects the installation sequence satisfying the condition specified by the software specifying unit 21 from among the installation sequence candidates obtained in the operation in S05 (S06). For example, in the operation in S06, the installation sequence selecting unit 27 may select an installation sequence of a lower cost as an appropriate one, or may select an installation sequence having the shortest installation time. Also in the operation in S06, the installation sequence selecting unit 27 may select an installation sequence having a fixed sequence, or may select an installation sequence having the lowest installation cost if a plurality of installation sequences is available.

In the operation in S06, the installation sequence selecting unit 27 may partition the number of products to be installed according to a job ratio of the installation job, or may partition the number of products to be installed according to the installation time. In the operation in S06, the installation sequence selecting unit 27 may select the installation sequence according to the setting difficulty level.

The installation executing unit 28 transmits the pieces of software as the installation targets stored on the software storage unit 30 to the target server 13 in accordance with the installation sequence obtained in S06, and executes the installation (S07).

Each process of the embodiment is specifically described below.

Data Example of Installation Information

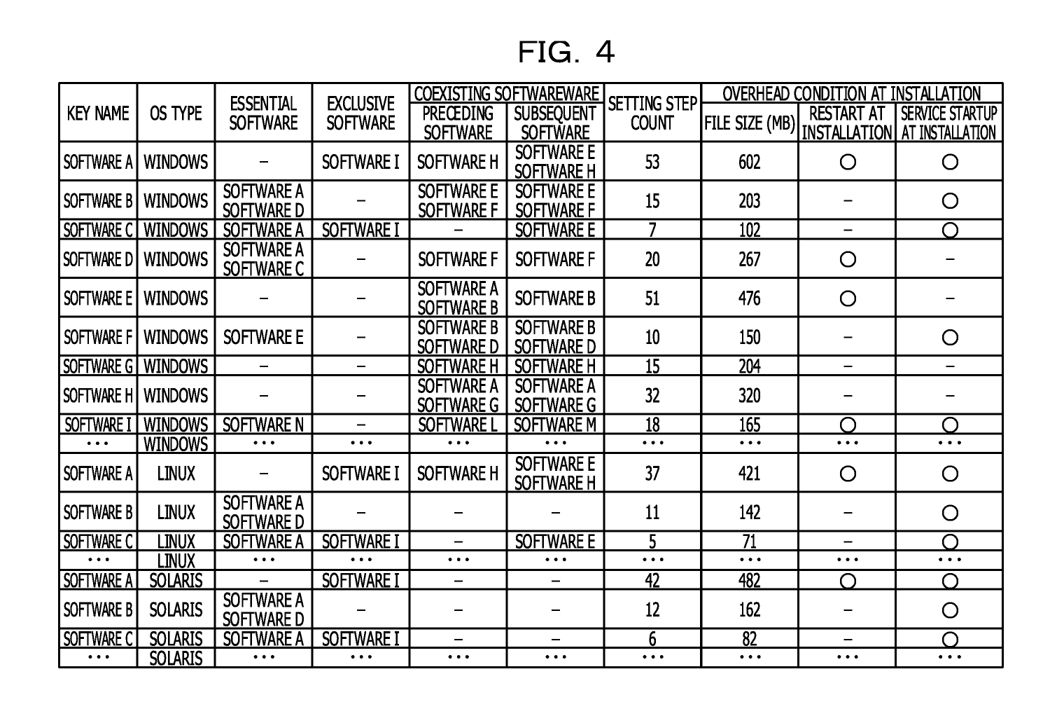

FIG. 4 is a table listing a data example of the installation information. The installation information of FIG. 4 is stored on the installation information storage unit 29. Items of the installation information of FIG. 4 include a key name, an OS type, essential software, exclusive software, coexisting software (preceding software and subsequent software), a set step count, overhead conditions at the installation (file size (MB), restart at installation and service startup at installation). The items are not limited to those of FIG. 4 in terms of contents, number, and sequence thereof.

The key name is information to identify software. The OS type is an identity of an OS on which the software of interest may work. The essential software is information that is used to install the software having the key name. The exclusive software is information of software that becomes exclusive when the software of the key name is installed. The coexisting software is a key name (software name) that may coexist with precedingly installed software or subsequently installed software.

The set step count is a numerical value that represents complexity (difficulty level of a job) when the software of the key name is installed. The set step count may be set according to criteria including but not limited to the number of screens set at graphical user interface (GUI) and the number of set items of definition files. By including the set step count into the installation information, the software to be installed may be sorted and installed according to the difficulty level. In this way, the install process may be performed efficiently by allowing software having a higher difficulty level to be handled together by a more skilled person.

The overhead condition at the installation is a process content that is performed when the software having the key name is installed. The file size (MB) is a storage capacity used at the installation. The restart at installation refers to whether restart is to be performed at the installation. If the restart is performed, the blank circle symbol is set. If the restart is not desired or if it does not matter whether the restart is performed or not, the symbol “-” is set. The symbols set herein are not limited to those. The service startup at installation is information as to whether the service startup is to be performed at the installation. If the service startup is performed, the blank circle symbol is set. If the service startup is not desired or if it does not matter whether the service startup is performed or not, the symbol “-” is set. The symbols set herein are not limited to those.

Software Specifying Process

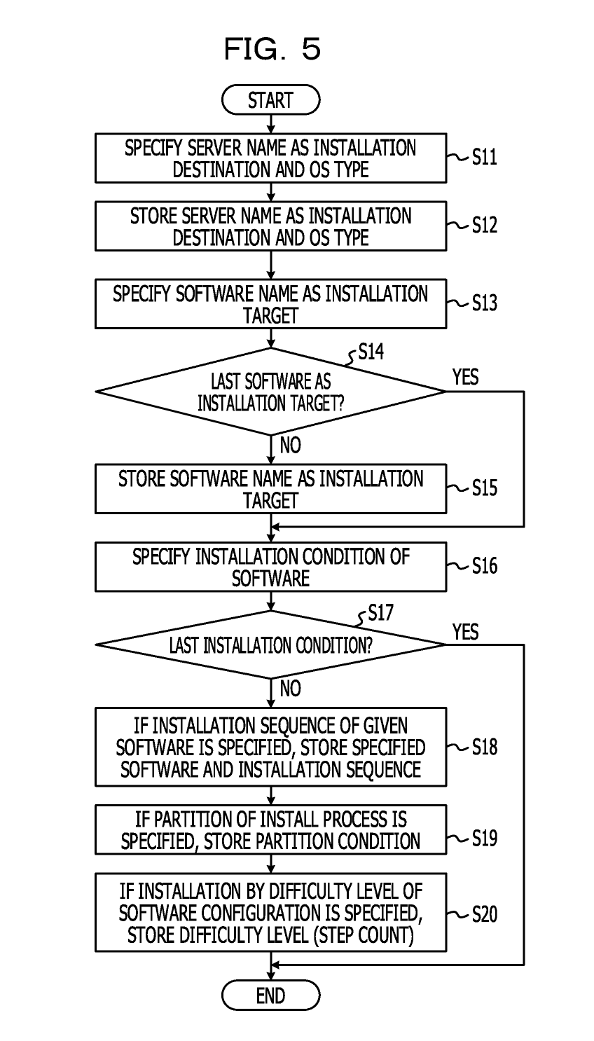

A software specifying process of the software specifying unit 21 is described with reference to a flowchart of FIG. 5. FIG. 5 is the flowchart illustrating an example of the software specifying process. Referring to FIG. 5, the software specifying unit 21 specifies an OS type and a server name as an installation destination indicated by the user (S11), and stores the specified server name as the installation destination and OS type on a memory (such as the main memory device 45) (S12).

The software specifying unit 21 specifies a software name of the software as an installation target (S13), and determines whether the software is last target software (S14). If the software is not last target software (no branch from S14), the software specifying unit 21 stores the software name as an installation target on the memory or the like (S15). If the software is last target software (yes branch from S14), or subsequent to the operation in S15, the software specifying unit 21 specifies the installation condition of the software (S16).

The software specifying unit 21 determines whether the installation condition is last installation condition (S17). If the installation condition is not last installation condition (no branch from S17), processing proceeds to S18. If the installation sequence of given software is specified, the software specifying unit 21 stores the specified software and the installation sequence on the memory (S18). If the partition of an installation job is specified, the software specifying unit 21 stores a partition condition on the memory (S19). The partition condition includes but is not limited to the partition of the installation job by a job ratio or the partition by installation time.

If the installation by the difficulty level of software configuration is specified, the software specifying unit 21 stores the difficulty level (the step count) on the memory (S20). If the installation condition is last installation condition in S17 or subsequent to the operation in S20, the software specifying unit 21 ends the process. The process of FIG. 5 is repeated until all the software to be installed has been completed.

Installation Information Collecting Process

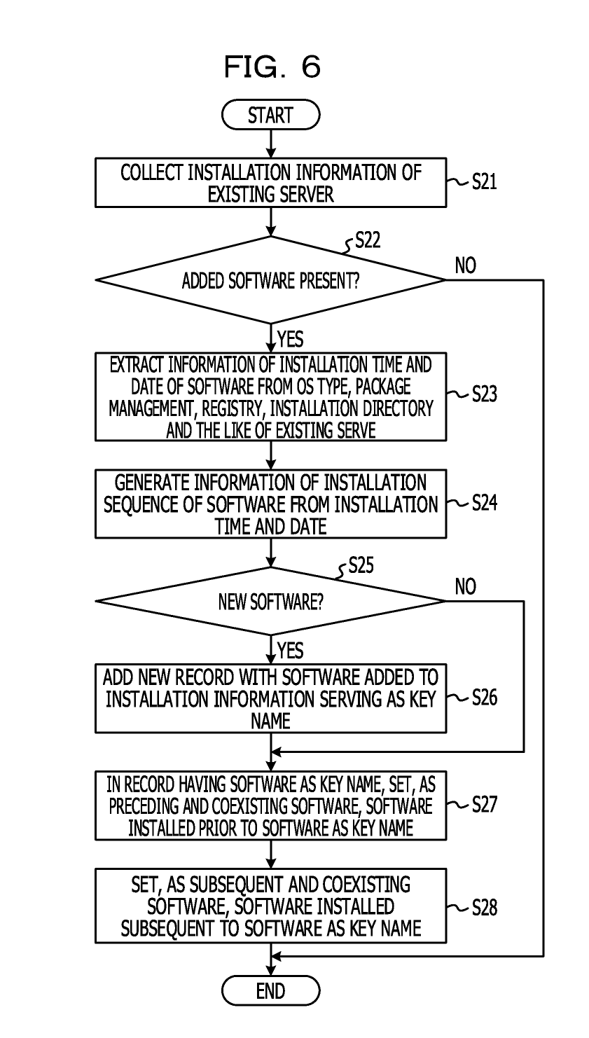

An installation information collecting process of the installation information collecting unit 23 is described below with reference to a flowchart of FIG. 6. FIG. 6 is the flowchart illustrating an example of the installation information collecting process. Referring to the example of FIG. 6, the installation information collecting unit 23 collects the installation information of the existing server 12 (S21), and determines whether any added software is present in the collected installation information in comparison with previous information (S22).

If added software is present (yes branch from S22), the installation information collecting unit 23 retrieves information of time and date of installation of the software from the OS type, package management, registry, installation directory and the like of the existing server 12 (S23). The installation information collecting unit 23 then generates information of the installation sequence of software from the installation time and date (S24), and then determines whether the installed software is new software (S25).

If the installed software is new software (yes branch from S25), the installation information collecting unit 23 adds a new record having as a key name the software newly added to the installation information (S26). If the installed software is not new software in S25 (no branch from S25), or subsequent to the operation in S26, the installation information collecting unit 23 sets, in the record having the soft as the key name, software installed prior to the software as the key name, as preceding and coexisting software (S27). The installation information collecting unit 23 also sets software installed subsequent to the software having the key name, as subsequent and coexisting software (S28).

Dependency Relationship Extraction Process

A dependency relationship extraction process of the dependency relationship extracting unit 24 is described with reference to flowcharts. The dependency relationship extraction process includes a route table production process and a grouping process by the dependency relationship, and these processes are separately described. In the following discussion, in the graph theory, a vertex is referred to as a node, and a branch is referred to as an edge. A start point of the edge having no arrow is referred to as a start node, and an end point of the edge having an arrow is referred to as an end node.

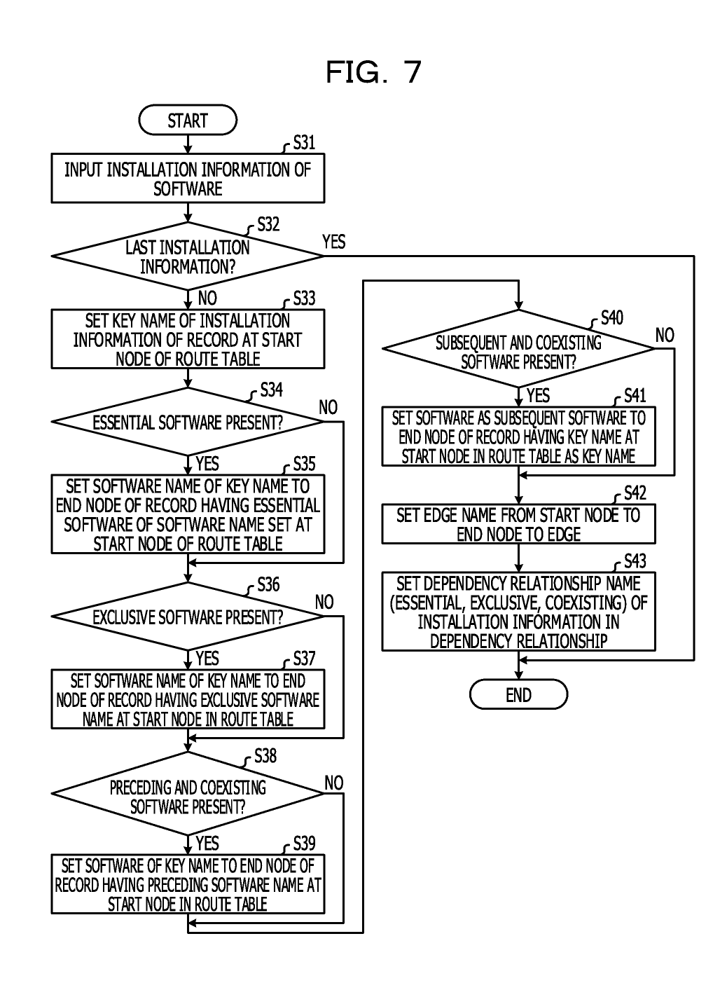

FIG. 7 is a flowchart illustrating an example of a route table production process. Referring to FIG. 7, the dependency relationship extracting unit 24 inputs the installation information of the software extracted by the installation information extracting unit 22 and the installation information of the software collected by the installation information collecting unit 23 (S31). The operation in S31 includes but is not limited to reading the extracted installation information on a record-by-record basis.

The dependency relationship extracting unit 24 then determines whether the installation information is last information (S32). If the installation information is not last information (no branch from S32), the dependency relationship extracting unit 24 sets the key name of the installation information of the record to the start node of the route table (S33). More specifically, the dependency relationship extracting unit 24 fills the route table in the order of the key names of the installation information, and thus sets key names of all pieces of software as installation targets at the start node.

The dependency relationship extracting unit 24 determines whether essential software is present (S34). If essential software is present (yes branch from S34), the dependency relationship extracting unit 24 sets the key name of the software to the end node of the record having as the essential software the software name set at the start node of the route table (S35). “Essential” is set to the dependency relationship.

If no essential software is present in the operation in S34 (no branch from S34), or subsequent to the operation in S35, the dependency relationship extracting unit 24 determines whether exclusive software is present (S36). If exclusive software is present (yes branch from S36), the dependency relationship extracting unit 24 sets the software of the key name to the end node of the record having an exclusive software name at the start node in the route table (S37).

If no exclusive software is preset in the operation in S36 (no branch from S36), or subsequent to the operation in S37, the dependency relationship extracting unit 24 determines whether preceding and coexisting software is present (S38). If preceding and coexisting software is present (yes branch from S38), the dependency relationship extracting unit 24 sets the software of the key name to the end node of the record having a preceding software name at the start node in the route table (S39).

If no preceding and coexisting software is not present in the operation in S38 (no branch from S38), or subsequent to the operation in S39, the dependency relationship extracting unit 24 determines whether subsequent and coexisting software is present (S40). If preceding and coexisting software is present (yes branch from S40), the dependency relationship extracting unit 24 sets the subsequent software to the end node of the recording having the key name at the start node in the route table (S41).

If no subsequent and coexisting software is present in the operation in S40 (no branch from S40) or subsequent to the operation in S41, the dependency relationship extracting unit 24 sets an edge name from the start node to the end node to an edge in the route table (S42). The dependency relationship extracting unit 24 then sets a dependency relationship name (such as essential, exclusive, or coexisting) of the installation information in the dependency relationship in the route table (S43), and ends the process. “Essential” is set in the dependency relationship name in the operation in S43 if the operation in S35 is performed. “Exclusive” is set in the dependency relationship name in the operation in S43 if the operation in S37 is performed. “Coexisting” is set in the dependency relationship name in the operation in S43 if the operations of S39 and S41 are performed. The process is not limited to this setting.

If the installation information is last in the operation in S32 (yes branch from S32), the dependency relationship extracting unit 24 ends the process. The process of FIG. 7 is repeated until all the installation information has been processed.

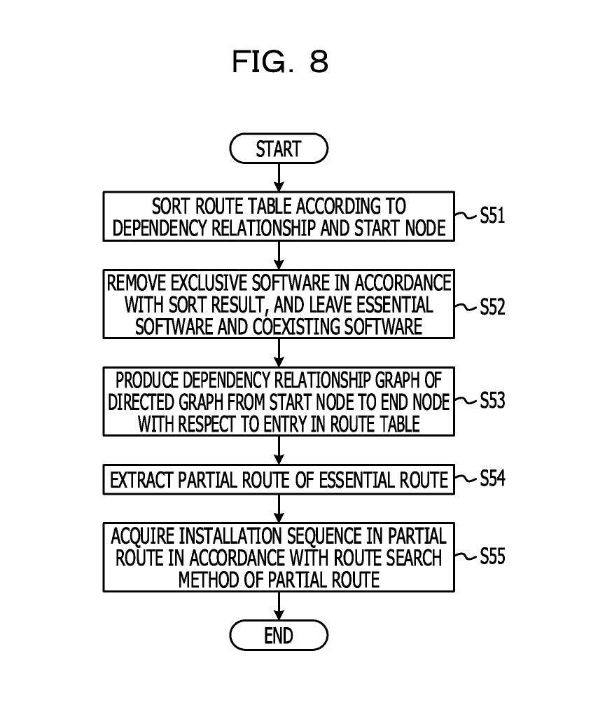

FIG. 8 is a flowchart illustrating an example of a grouping process performed according to a dependency relationship. Referring to FIG. 8, the dependency relationship extracting unit 24 sorts the route table using the dependency relationship and the start node as keys (S51), removes exclusive software in accordance with sort results, and leave the essential and coexisting software (S52).

The dependency relationship extracting unit 24 produces a graph of a dependency relationship of a directed graph from a start node to an end node with reference to an entry of the route table obtained as a result of operation in S52 (S53). The dependency relationship extracting unit 24 also extracts a partial route of an essential route (S54), and then acquires the installation sequence in the extracted partial route using the route search method (S55).

Example of Route Table

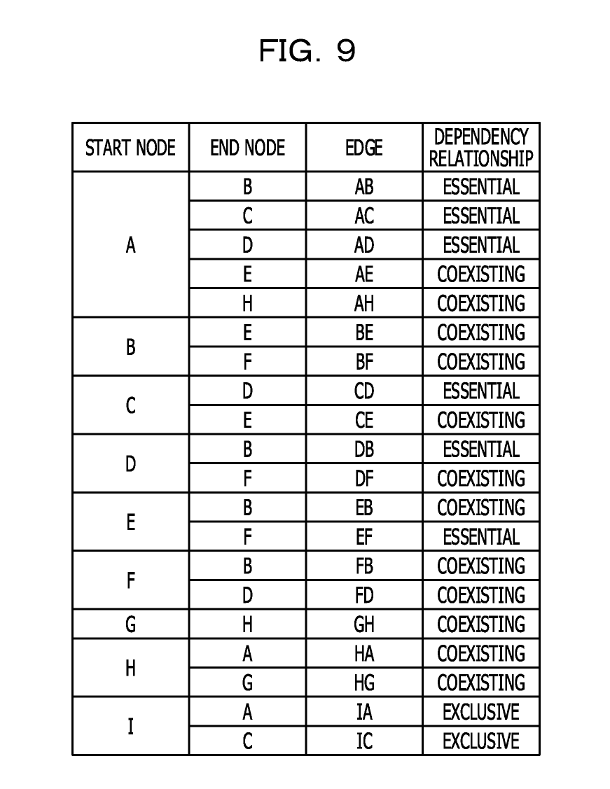

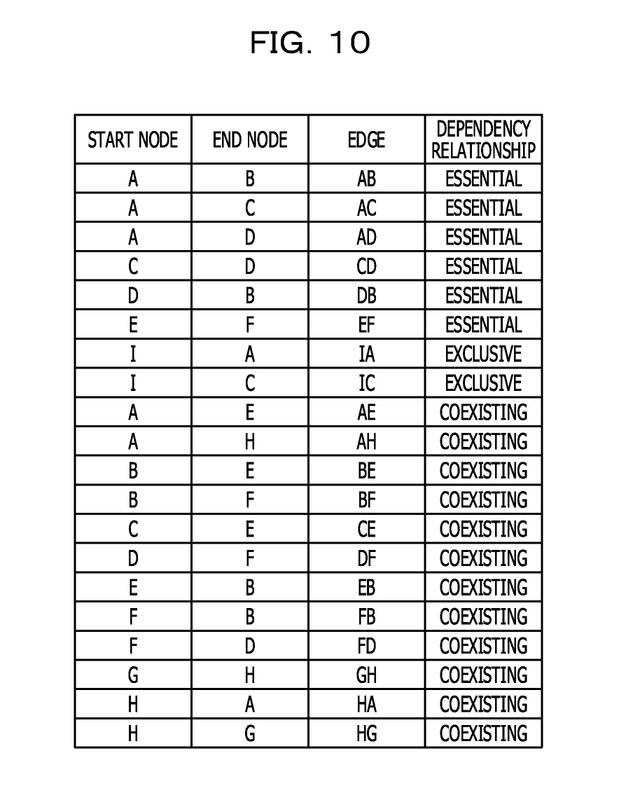

FIG. 9 and FIG. 10 illustrate (first and second) route table examples. FIG. 9 illustrates a route table of each start node obtained in the process of FIG. 7, and FIG. 10 illustrates a route table that has been sorted according to the dependency relationship in the process of FIG. 8.

Items of the route table of FIG. 9 and FIG. 10 include the start node, the end node, the edge, the dependency relationship, and the like. The route tables are not limited to the items FIG. 9 and FIG. 10 in terms of the content, type, and sequence thereof.

FIG. 9 and FIG. 10 illustrate the route tables of the sequence according to which a plurality of pieces of software is installed. The start node is a key name serving as a start point of software. The end node is a key name serving an end point of the software. The edge is information that connects the start node and the end node. The dependency relationship represents a relationship between the start node and the end node. The dependency relationship includes but is not limited to essential, coexisting, and exclusive.

Example of Directed Graph

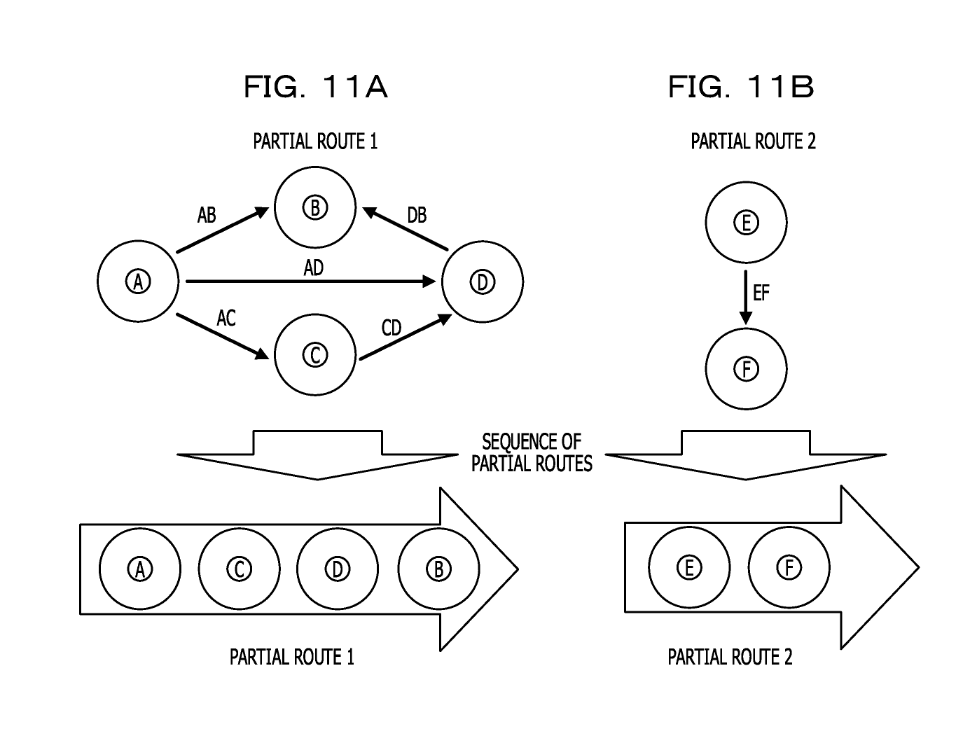

FIG. 11A and FIG. 11B illustrate examples of directed graphs. Referring to FIG. 11A, a node of a directed graph includes but is not limited to a recording medium (disk) that in a readable fashion stores software to be installed.

In the example of FIG. 11A and FIG. 11B, the start node is connected to the end node via an edge, and the edge is labeled a name including the start node and the end node. By repeating this operation, a partial route is produced. The partial route starts with a node having no end node and terminates with a node having no start node.

In the example of FIG. 11A, edges AB, AC, and AD are respectively set up between software A as a start node and software B as an end node, between the software A as the start node and software C as an end node, and the software A as the start node and software D as an end node. Also in the example of FIG. 11A, an edge CD is set up between the software C as a start node and the software D as the end node, and an edge DB is set up between the software D as a start node and the software B as an end node.

Using a route search method, the dependency relationship extracting unit 24 determines the installation sequence in a partial route 1 in the essential relationship illustrated in FIG. 11A. Since only a single directivity is present in the installation sequence in the partial route, the installation sequence is determined using a route search method, such as topological sorting. In the topological sorting, a node having no end node is to be found in the route first, that rout is removed, a node having no end node is then to be found in the route with the first node excluded, and the second node is then removed. In the topological sorting, the above operation is repeated until the remaining nodes in the route becomes one, and the shortest route is determined in the sequence of excluded nodes.

In the example of FIG. 11A, the dependency relationship extracting unit 24 finds the software A not becoming an end node from among the software A, the software B, the software C, and the software D of the partial route 1, and then removes the software A. The dependency relationship extracting unit 24 remove the software C not becoming an end node from among the remaining software B, software C, and software D. The dependency relationship extracting unit 24 removes the software D not becoming an end node from among the remaining software B and software D. In this way, the dependency relationship extracting unit 24 obtains the installation sequence of the partial route “software A→software C→software D→software B”.

In the example of FIG. 11B, only an edge EF is set up between start software E to end software F. An installation sequence of a partial route 2 “software E→software F” results.

Installation Candidate Extraction Process

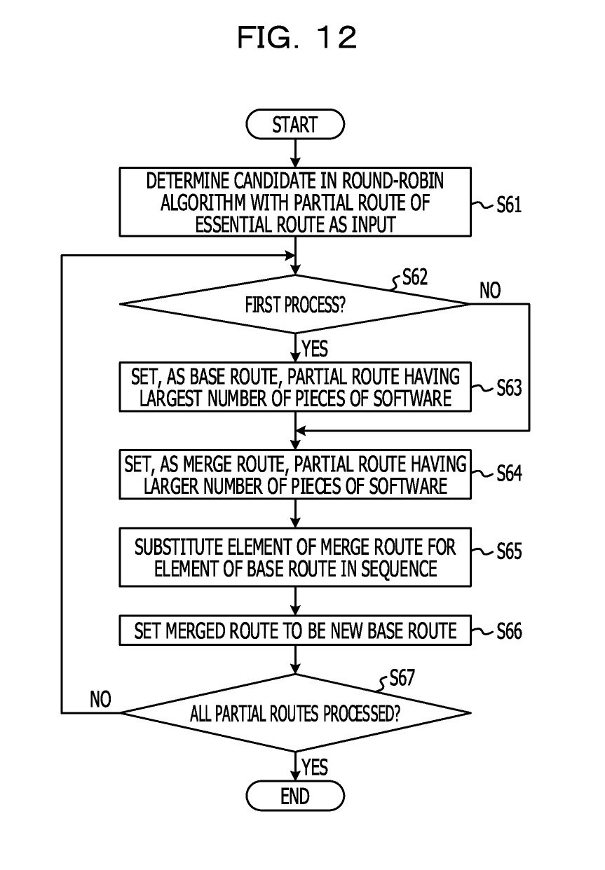

An installation candidate extraction process of the installation candidate extracting unit 25 is described with reference to a flowchart of FIG. 12. FIG. 12 is the flowchart illustrating an example of the installation candidate extraction process. In the example of FIG. 12, the installation candidate extracting unit 25 determines a candidate in a round-robin algorithm by inputting a partial route of an essential route (S61).

The installation candidate extracting unit 25 determines whether the process is a first process (S62). If the process is a first process (yes branch from S62), the installation candidate extracting unit 25 sets a route having the largest number of pieces of software forming the partial route to be a base route (S63). If the process is not a first process (no branch from S62), or subsequent to the operation in S63, the installation candidate extracting unit 25 sets a partial route having a larger number of pieces of software to be a merge route (S64).

The installation candidate extracting unit 25 substitutes elements of the merge route for elements of the base route in sequence (S65), and sets the merged route to be a new base route (S66).

The installation candidate extracting unit 25 determines whether all the partial routes have been processed (S67). If all the partial routes have not yet been processed (no branch from S67), the installation candidate extracting unit 25 returns to the operation in S62 to process an unprocessed partial route. If all the partial routes have been processed (yes branch from S67), the installation candidate extracting unit 25 ends the process.

Example of installation sequence candidate in essential relationship

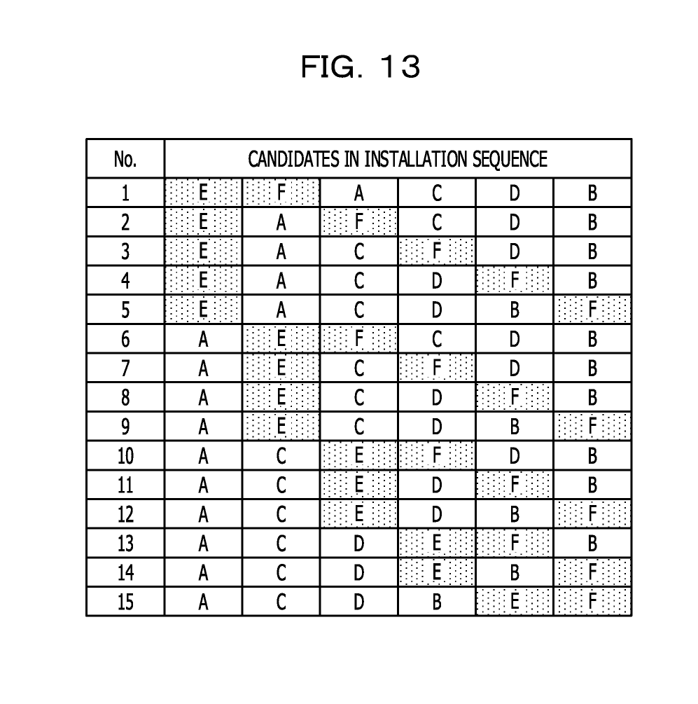

FIG. 13 illustrates an example of installation sequence candidates based on an essential relationship. Alphabets in FIG. 13 represent software names (key names). The example of FIG. 13 corresponds to the directed graphs in FIG. 11A and FIG. 11B.

If combinations of the installation sequences are determined in a round-robin searching with the sequence of “software A→software C→software D→software B” of the partial route 1 and “software E→software F” of the partial route 2 maintained, “15 combinations of installation sequence candidates of the essential relationship” are determined.

FIG. 13, listing 15 identification numbers (No.), thus illustrates that in the installation sequence candidates are installed in sequence from left to right. The installation sequence of the coexisting relationship is found to be sequence of software E→software C. As a result, the installation sequence candidates are a total of six combinations of No. 10 through No. 15 of FIG. 13.

Installation Cost Calculation Process

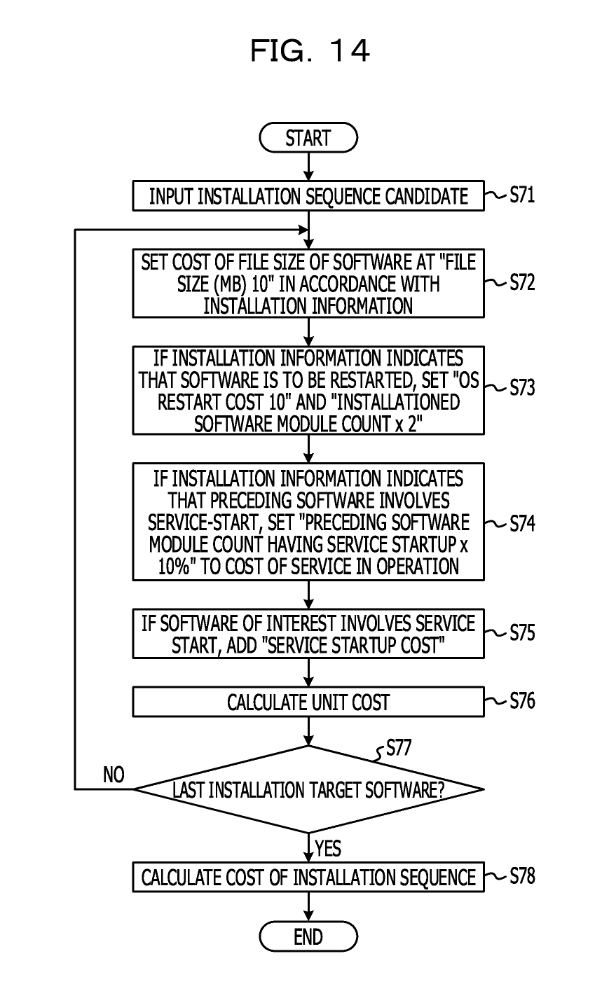

An installation cost calculation process of the installation cost calculating unit 26 is described with reference to a flowchart of FIG. 14. FIG. 14 is the flowchart illustrating an example of the installation cost calculation process.

Referring to FIG. 14, the installation cost calculating unit 26 inputs the installation sequence candidates (S71), and performs the following process on all the installation sequence candidates.

The installation cost calculating unit 26 sets the cost of the file size of software to “file size (MB)/10” in accordance with the installation information, for example (S72). If the installation information indicates that the software is to be restarted, the installation cost calculating unit 26 sets “OS restart cost 10” and “installed software module count×2” (S73). If the installation information indicates that preceding software involves service function, the installation cost calculating unit 26 then sets “preceding software count having service startup×10%” to cost of service in operation (S74). If service startup is to be performed on the software of interest, the installation cost calculating unit 26 adds “service startup cost 1” (S75).

The installation cost calculating unit 26 calculates a unit cost (S76). The unit cost includes but is not limited to “file size cost+restart cost+service startup cost+cost influenced by the service in operation”. For example, the unit cost may be calculated using at least one of the file size cost, the restart cost, the service startup cost, and the cost influenced by the service in operation.

The installation cost calculating unit 26 determines whether the software is last software to be installed (S77). If the software is not last software to install (no branch from S77), the installation cost calculating unit 26 returns to the operation in S72 and performs the process on the next software.

If the software is last software to be installed in the operation in S77, the installation cost calculating unit 26 calculates the cost of the installation sequence as the candidate (S78). In the cost calculation, the cost of the installation sequence includes but is not limited to “a total sum of unit costs of target software”.

Via the installation cost calculation process described above, the cost (installation load) of each installation sequence candidate is calculated. Conditions indicated in FIG. 14 are processed in accordance with a cost criteria table that is set in advance.

Example of Cost Criteria Table

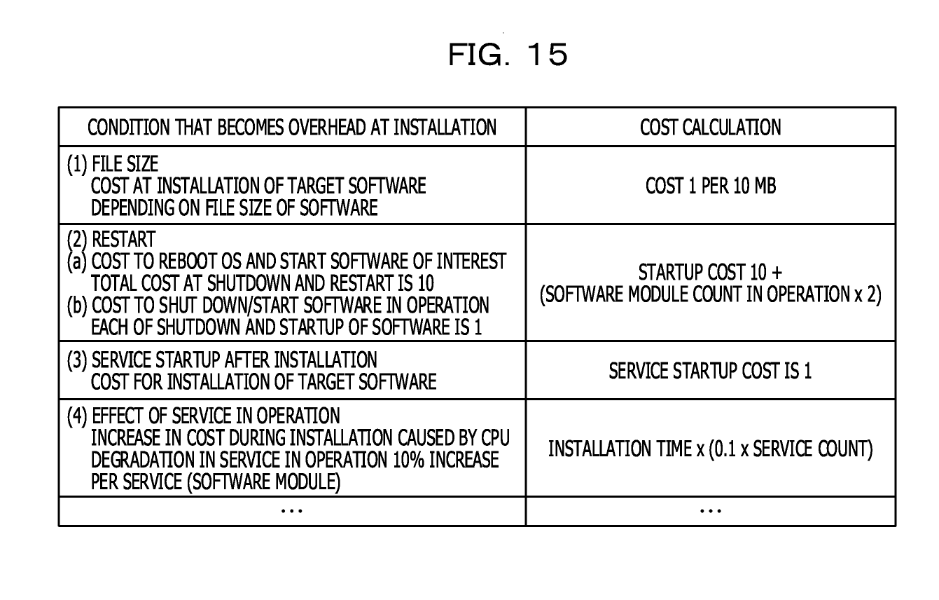

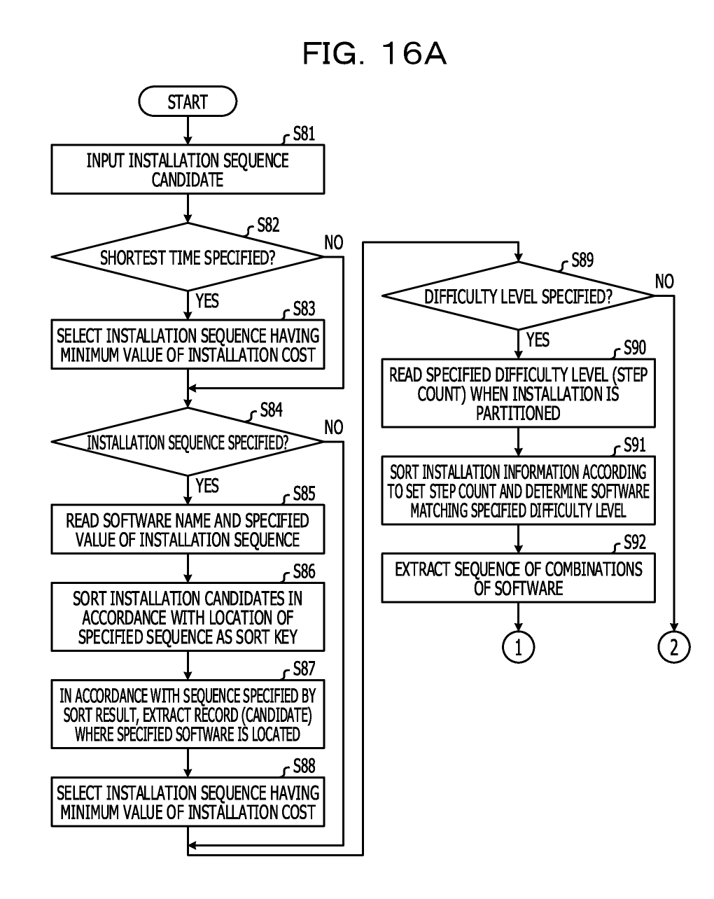

FIG. 15 illustrates an example of a cost criteria table. Listed in the example of FIG. 15 are conditions that become overheads at installation and cost calculations, but the conditions and the cost calculations are not limited to those listed herein.

For example, the installation time of software varies depending on a physical quantity of software, such as a copy of each file, and is calculated using the cost criteria table of FIG. 15. For example, the cost of the file size is calculated with 10 MB set to be cost “1”. The cost of the file size refers to the cost incurred in the installation of target software, and depends on the file size of the software.

If the restart is to be performed after the installation of the software, an OS restart (including shutdown) takes time, and shutdown and restart of software in operation also take time. The restart cost includes a cost to restart the OS and to restart the software of interest, and a cost to shut down and restart the software in operation.

In the embodiment, the restart cost to restart the OS including the shutdown cost and the restart cost is set to be “10”, and the shutdown cost and the restart cost of installed software (in operation) are respectively set to be “1” as illustrated in FIG. 15. The restart cost is thus calculated as “restart cost 10+(software module count in operation×2)”.

If a service startup is to be performed subsequent to the installation of the software, the operation of the service startup takes time. In accordance with the embodiment, the cost is calculated with the cost involved in the service startup subsequent to the installation set to be “1” as illustrated in FIG. 15. This cost is incurred in the installation of the target software, for example.

The cost influenced by the service in operation is a 10% increase per service (software) in the installation time increased by a CPU slowdown responsive to the service in operation, for example. Referring to FIG. 15, calculating the cost influenced by the service in operation may result in “installation time×(0.1×service count)”. The service count includes but is not limited to the number of pieces of software in operation. In the embodiment, the installation cost is calculated by calculating the cost of each piece of software at a location in the installation sequence and then by summing the costs of all the pieces of software.

Installation Sequence Selection Process

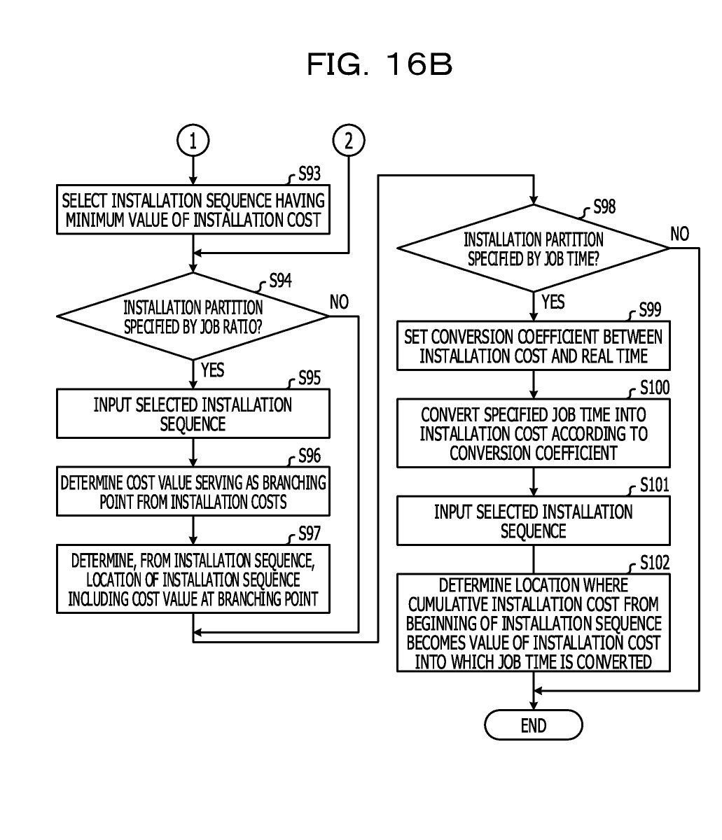

An installation sequence selection process of the installation sequence selecting unit 27 is described with reference to a flowchart of FIG. 16A and FIG. 16B. FIG. 16A and FIG. 16B are the flowchart illustrating an example of the installation sequence selection process.

In the example of FIG. 16A and FIG. 16B, the installation sequence selecting unit 27 inputs an installation sequence candidate (S81), and then determines whether the shortest time is specified by the software specifying unit 21 or the like (S82). If the shortest time is specified (yes branch from S82), the installation sequence selecting unit 27 selects the installation sequence having a minimum value of installation cost obtained by the installation cost calculating unit 26 (S83).

If the shortest time is not specified in the operation in S82 (no branch from S82), or subsequent to the operation is S83, the installation sequence selecting unit 27 determines whether an installation sequence is specified by the software specifying unit 21 or the like (S84). If an installation sequence is specified (yes branch from S84), the installation sequence selecting unit 27 reads the software name and the installation sequence (S85), and sorts installation candidates according to the location of the specified sequence as a sort key (S86). The installation sequence selecting unit 27 also extracts a record (candidate) where the software specified in the sequence specified by the sort result is located (S87), and selects an installation sequence having a minimum installation cost (S88).

If no installation sequence is specified in the operation in S84 (no branch from S84), or subsequent to the operation in S88, the installation sequence selecting unit 27 determines whether a difficulty level is specified by the software specifying unit 21 or the like (S89). If a difficulty level is specified (yes branch from S89), the installation sequence selecting unit 27 reads the specified difficulty level (step count) when the installation is specified (S90). The installation sequence selecting unit 27 also sorts the installation information according to the set step count and determines software that matches the specified difficulty level (S91). The operation in S91 includes but is not limited to determining a combination of pieces of software, each having a step count equal to or above 50. The installation sequence selecting unit 27 then extracts a sequence of software combinations (S92). The installation sequence selecting unit 27 selects a installation sequence having a minimum value of installation cost from among the extracted combination sequences (S93).

If no difficulty level is specified in the operation in S89 (no branch from S89), or subsequent to the operation in S93, the installation sequence selecting unit 27 determines whether an installation partition by a job ratio is specified by the software specifying unit 21 or the like (S94). If an installation partition by a job ratio is specified (yes branch from S94), the installation sequence selecting unit 27 inputs the selected installation sequence (S95), and determines a cost value serving as a branching point from the input installation costs (S96). The operation in S96 includes but is not limited to determining the cost value of the branching point as “installation cost/job ratio”. The installation sequence selecting unit 27 further determines, from the installation sequence, the location of the installation sequence including the cost value at the branching point (S97).

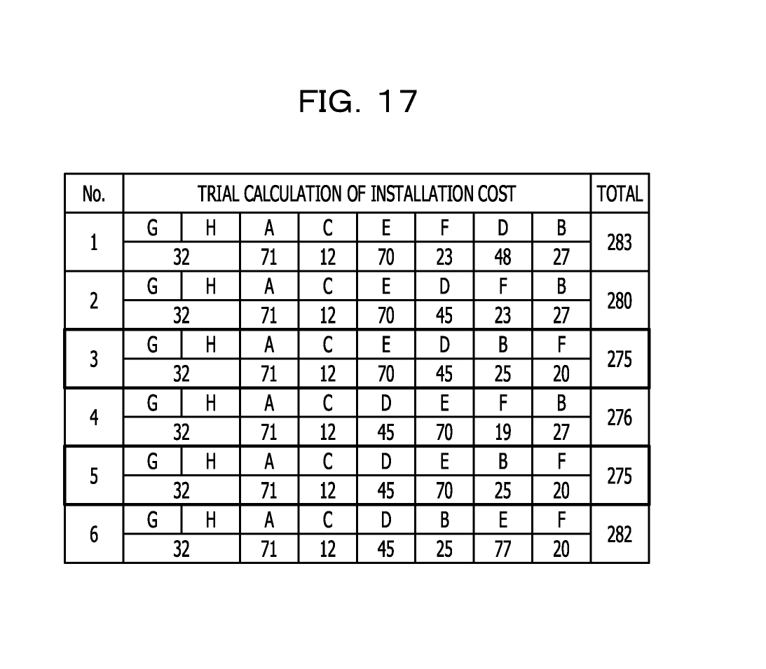

If an installation partition by a job ratio is not specified in S94 (no branch from S94), or subsequent to the operation in S97, the installation sequence selecting unit 27 determines whether an installation partition by job time is specified by the software specifying unit 21 or the like (S98). If an installation partition by job time is specified (yes branch from S98), the installation sequence selecting unit 27 sets a conversion coefficient between the installation cost and the real time (S99), and converts the specified job time into the installation cost by the conversion coefficient (S100). The installation sequence selecting unit 27 then inputs the selected installation sequence (S101) and then determines the location where the cumulative installation cost from the beginning of the installation sequence becomes the value of the installation cost into which the job time is converted (S102). In the embodiment, the installation sequence is selected by performing the above process. In each of the specifying operations in S82, S84, S89, S94 and S98, the software specifying unit 21 or the like specifies at least one setting, but the sequence of the operations are not limited to the sequence of FIG. 16A, FIG. 16B, and FIG. 17.

### EXAMPLES

Examples to select the installation sequence in the embodiment are described below. In the discussion that follows, the software specifying unit 21 or the like specifies nine pieces of software, software A through software I, as installation targets to the existing server 12, and further specifies installation conditions in first through sixth examples described below. However, the embodiment is not limited to this method.

### First Example

A first example is a selection example of the installation sequence in which the software A through the software I are installed during the shortest period of time. In the first example, the dependency relationship of software is denoted by a directed graph. For example, the installation information extracting unit 22 searches the installation information storage unit 29 for the software A through the software J specified by the software specifying unit 21, and then extracts the installation information of each piece of software as illustrated in FIG. 4.

The dependency relationship extracting unit 24 produces a route table of target software of FIG. 9 in response to the extracted installation information under the conditions described below. The dependency relationship extracting unit 24 first sets all the software A through J as installation targets at start nodes in the route table. Referring to FIG. 4, the software A has no essential software, and no essential software is set in the route table (FIG. 9). Referring to FIG. 4, the software A includes exclusive software I. In the route table (FIG. 9), the software A is set to the start node, the software I is set to the end node, IA is set to the edge, and exclusive is set to the dependency relationship. Also, referring to FIG. 4, the software A includes software H as preceding and coexisting software. In the route table (FIG. 9), the software A is set to the start node, the software H is set to the end node, HA is set to the edge, and coexisting is set to the dependency relationship.

Referring to FIG. 4, the software A includes subsequent software E and H. The software A is set to the start node, the software E and H are set to the end nodes, AE and AH are set to the edges, and coexisting is set to the dependency relationship. Referring to FIG. 4, the software B includes essential software A. In the route table (FIG. 9) the software A is set to the start node, the software B is set to the end node, AB is set to the edge, and essential is set to the dependency relationship. Similarly, the software B includes essential software D. In the route table (FIG. 9), the software B is set to the start node, the software D is set to the end node, DB is set to the edge, and essential is set to the dependency relationship.

The software B includes no exclusive software as illustrated in FIG. 4, and no exclusive software is set in the route table (FIG. 9). The software B includes software E as preceding and coexisting software. In the route table (FIG. 9), the software B is set to the start node, the software E is set to the end node, EB is set to the edge, and coexisting is set to the dependency relationship. Similarly, the software B includes software F as preceding and coexisting software. In the route table (FIG. 9), the software B is set to the start node, the software F is set to the end node, FB is set to the edge, and coexisting is set to the dependency relationship.

Referring to FIG. 4, the software B includes subsequent and coexisting software E and F. The software B is to the start node, the software E and F are set to the end node, BE and BF are set to the edge, and coexisting is set to the dependency relationship.

Similarly, the software C through I are set as listed in the route table of FIG. 9. The dependency relationship extracting unit 24 sorts the produced route table with the dependency relationship specified as a first key and the start node specified as a second key, thereby obtaining the route table sorted according to the dependency relationship (FIG. 10). In the route table sorted according to the dependency relationship (FIG. 10), the software I at the start node is the exclusive software of the software A and the software C, and no software having the software I at the end node is present. The software I is thus removed as exclusive software. The directed graphs of the essential relationship of FIG. 11A and FIG. 11B are thus obtained from the start nodes and the end nodes having the essential relationship in accordance with the route table sorted according to the dependency relationship (FIG. 10).

The software G and the software H having only a coexisting dependency relationship are free from the restart and the service startup, and do not affect time of the entire installation in sequence. The software G and the software H are installed first in parallel. A higher one of the costs of the software G and the software H is used in this case.

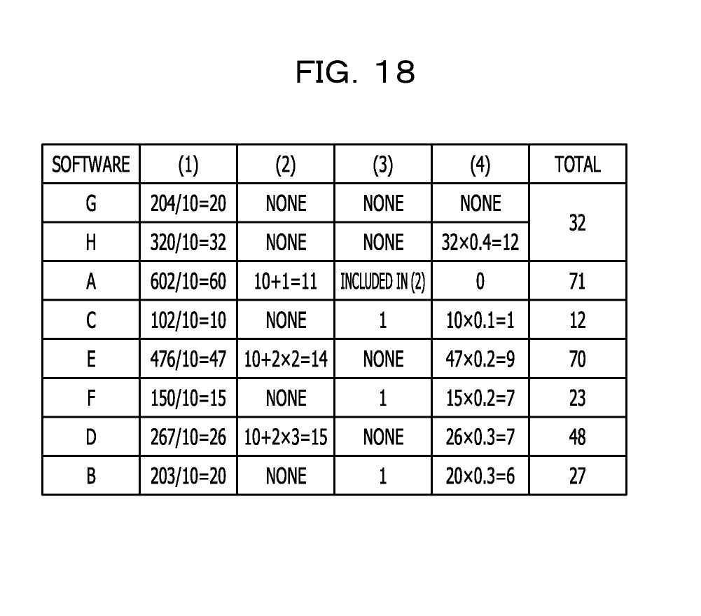

FIG. 17 illustrates a calculation example of installation costs in the first example. FIG. 18 illustrates an example of cost calculation results in the first example. Note that FIG. 18 illustrates cost calculation results corresponding to the software sequence of No. 1 candidate of FIG. 17.

The cost calculation of FIG. 18 is performed in accordance with the cost criteria table of FIG. 15. A column (1) of FIG. 18 lists costs of file sizes, a column (2) of FIG. 18 lists costs of OS restarts, a column (3) of FIG. 18 lists costs of service startups, and a column (4) of FIG. 18 lists costs influenced by the services in operation. The word “none” of FIG. 18 refers to software that does not satisfy the corresponding criteria. The total of the costs in each piece of software in FIG. 18 is typically, but not limited to, the sum of values calculated at the columns (1) through (4).

Since the software G and H are installed in parallel in the examples of FIG. 17 and FIG. 18, the higher cost (32) is counted in the sum. In the example of FIG. 17, the installation cost of the first candidate (No. 1) is 283.

The calculated installation costs of the second candidate (No. 2) through the sixth candidate (No. 6) are thus listed as illustrated in FIG. 17. No. 3 (G→H→A→C→E→D→B→F) and No. 5 (G→H→A→C→D→E→B→F) have the shortest installation sequence with a cost of 275. One of the installation sequence candidates is selected, and the install process is performed in the selected installation sequence on the destination server 13. If a plurality of candidates is selected, one candidate is set in accordance with a preset priority condition. In the example of FIG. 17, the priority condition is that a smaller candidate number has a higher priority, and No. 3 is thus selected. The priority condition is not limited to this. Another priority condition may be set up.

The above calculation is performed in accordance with the file size cost (1), the OS restart cost (2), the service startup cost (3), and the cost influenced by the service in operation (4) serving as measures. The measures are not limited to those described herein. The cost calculation may be performed using at least one of the measures.

### Second Example

A second example is a selection example of the installation sequence in which the software A through the software I are installed with the software D installed last. In the second example, the specified sequence has a higher priority and thus overrides the sequence of the software E→the software C in the installation sequence of the coexisting relationship. In the directed graph of the second example of FIG. 11A, the software D is to be installed prior to the software B because of the essential relationship of the partial route 1, and the sequence of the software D→the software B is to be followed.

In the second example, the installation sequence candidates of the essential relationship in the fifth column from the left as illustrated in FIG. 13 are sorted to determine a candidate having the software D at the penultimate location. As a result, six installation sequence candidates including No. 1 through No. 3, No. 6, No. 7, and No. 10 of FIG. 13 are obtained.

The software G and the software H having only a coexisting dependency relationship are free from the restart and the service startup, and do not affect time of the entire installation in sequence. In the second example, the software G and the software H are installed first.

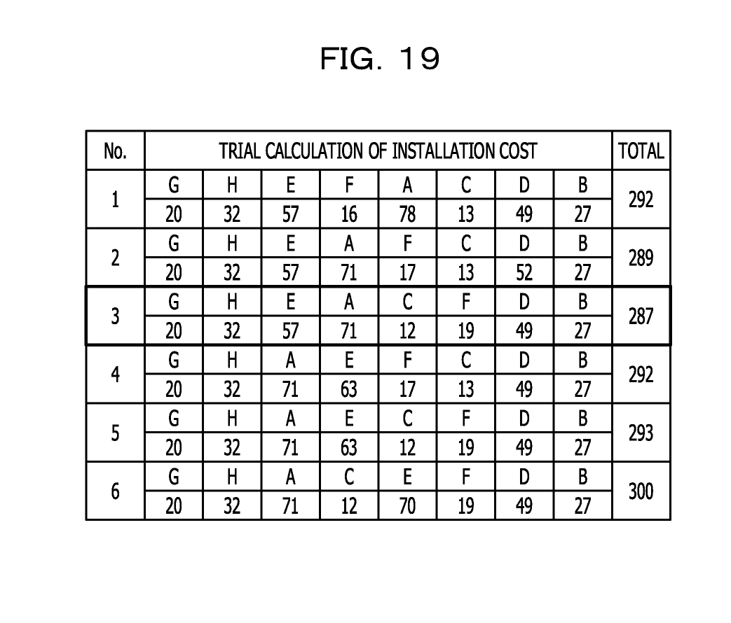

In the second example, the installation cost calculating unit 26 determines the installation costs in the installation sequences. FIG. 19 illustrates an example of cost calculation results in the second example. In the example of FIG. 19, No. 3 (D→H→E→A→C∝F→D→G) has the shortest installation sequence with a cost of 287. This installation sequence is thus selected, and the install process is performed in the selected installation sequence on the destination server 13.

### Third Example

A third example is a selection example of the installation sequence in which software having a set step count of 50 or above from among the software A through the software I is installed together.

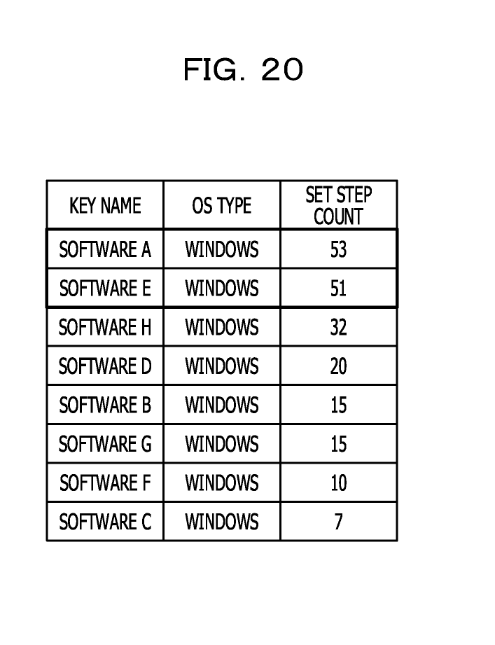

FIG. 20 illustrates an example of sorting performed according to a set step count in the installation information. If the software A through the software H are sorted in the order from high to low set step count, results of FIG. 20 are obtained. In the example of FIG. 20, OS includes but is not limited to only Windows. The same process may be performed on another OS, such as Linux.

The difficulty level of the software A and the software E is higher in the example of FIG. 20. The specified sequence has a higher priority and thus overrides the sequence of the software E→the software C in the installation sequence of the coexisting relationship.

A candidate where the software A and the software E are consecutively arranged is determined from among the installation sequence candidates in the essential relationship of FIG. 13. As a result, eight installation sequence candidates of No. 2 through No. 9 are determined.

The software G and the software H having only a coexisting dependency relationship are free from the restart and the service startup, and do not affect time of the entire installation in sequence. The software G and the software H are installed last.

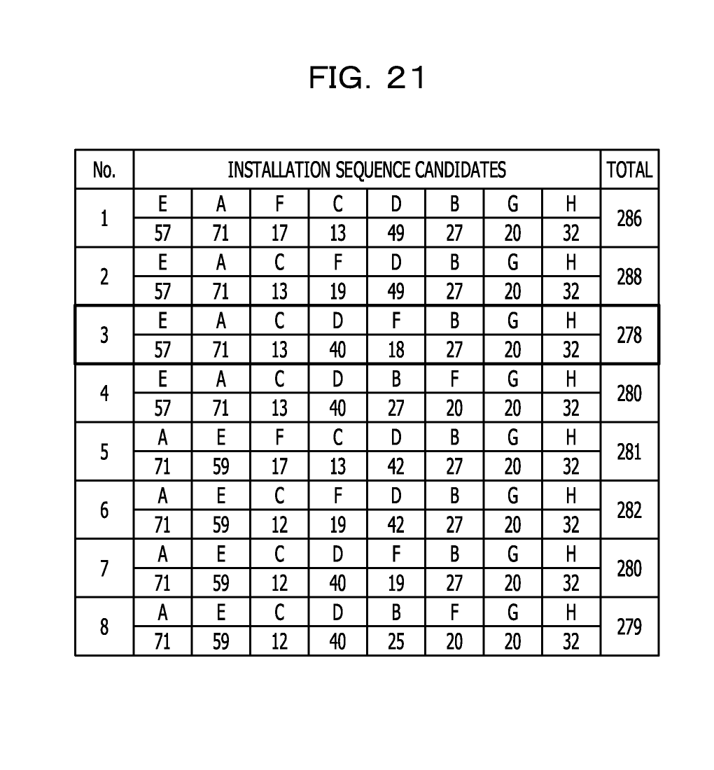

The installation cost is determined in each installation sequence. FIG. 21 illustrates an example of cost calculation results in the third example. In the example of FIG. 21, the cost calculation results in No. 3 (E→A→C→D→F→B→G→H) having the shortest installation sequence with a cost of 278. This installation sequence is thus, and the install process is performed in the selected installation sequence on the destination server 13.

### Fourth Example

A fourth example is a selection example of the installation sequence in which the installation job having the shortest time of the first example is equally partitioned into two parts by a job ratio.

If the installation job of the installation sequence determined in the first example (No. 3 in FIG. 11) is partitioned into two parts by a job ratio, the resulting cost is at a location corresponding to half of 275 (G→H→A→C→E→D→B→F: cost 275), thus, 137.5.

A cumulative job cost in this sequence is a parenthesized value as follows: G→H (32)→A (103)→C (115)→E (185)→D (230)→B (255)→F (275). If the sequence is partitioned into “G→H→A→C” and “E→D→B→F”, a condition closest to the two-part partition results.

In the fourth example, the installation job is equally partitioned in accordance with the calculated cost. The number of partitions is not limited to two. The installation job may be partitioned by three or higher number.

### Fifth Example

A fifth example is a selection example of the installation sequence in which the coexisting relationship is automatically learned from the installation information from the existing server 12 and the learned information is used. In the fifth example, the installation information collecting unit 23 collects information of software installed on the existing server 12, the coexisting relationship of the installed software is extracted from the collected information, and the extracted information is added to the installation information of the software managed by the installation information storage unit 29. The automatic learning process is thus performed on the installation information. Since the additional information of the installation information is different depending on the OS and the like of the existing server 12, the automatic learning process is specifically described below.

Example of Software Addition to Windows Server

An example of a software addition to a Windows server is described below. If software R is newly installed on the existing server 12-1, the installation information collecting unit 23 may collect the installation information of the software R. The installation information collecting unit 23 may reference program management or directory information of the existing server 12-1 and collect information of the software A and the software B installed prior to the software R.

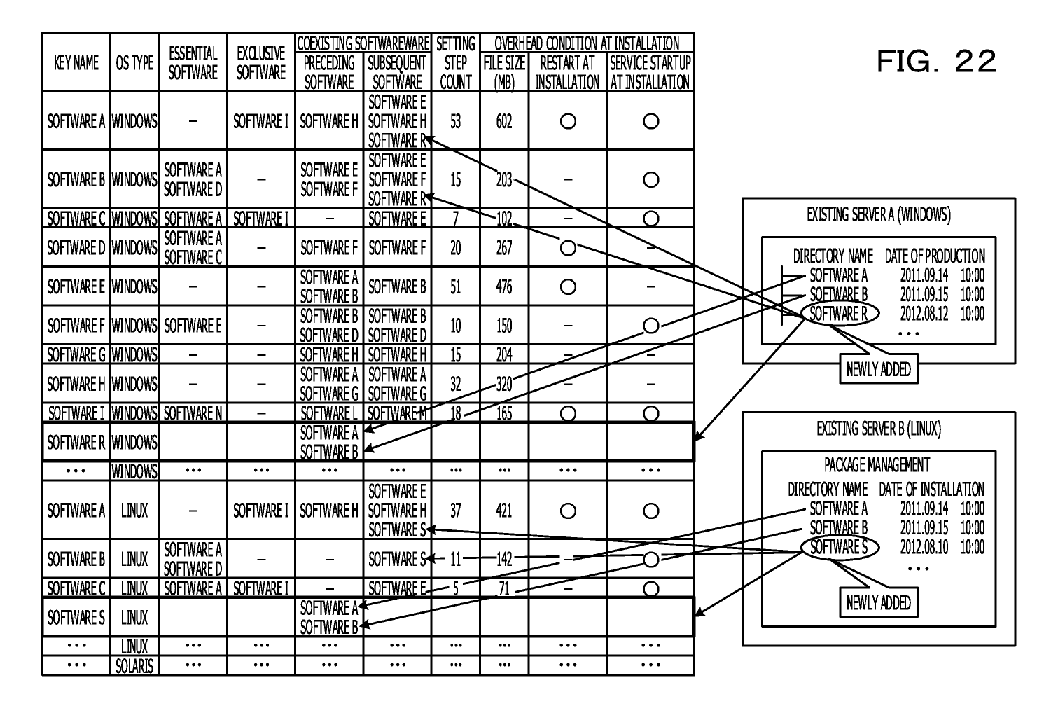

The installation information collecting unit 23 then adds the following information to the installation information managed by the installation information storage unit 29. FIG. 22 illustrates an example of automatic learning of the installation information. In the example of FIG. 22, the OS type is Windows, and records having the following key names are added to the installation information. “The software R is added to ‘subsequent and coexisting software’ having the software A as a key name”. “The software R is added to ‘subsequent and coexisting software’ having the software B as a key name”. “A record having the software R as a key name is added to the installation information because the software R is new software, and the software A and the software B are added to ‘preceding and coexisting software’”.

Example of Software Addition to Linux Server

An example of a software addition to a Linux server is described below. If software S is newly installed on the existing server 12-2, the installation information collecting unit 23 may collect the installation information of the software S. The installation information collecting unit 23 may reference package management of the existing server 12-2 and collect information of the software A and the software B installed prior to the installation of the software S.

The installation information collecting unit 23 then adds information illustrated in FIG. 22 to the installation information managed by the installation information storage unit 29. In the example of FIG. 22, the OS type is Linus, and records having the following key names are added to the installation information. “The software S is added to ‘subsequent and coexisting software’ having the software A as a key name”. “The software S is added to ‘subsequent and coexisting software’ having the software B as a key name”. “A record having the software S as a key name is added to the installation information because the software S is new software, and the software A and the software B are added to ‘preceding and coexisting software’”. In this way, the automatic learning is appropriately performed on the installation information in accordance with the OS type. Using the learned installation information, an appropriate installation sequence is selected with respect to a plurality of pieces of software, and the software is then installed on the destination server 13.

### Sixth Example

A sixth example is a selection example of the installation sequence in which a first job is to be completed within 4 hours from the start of the job when the installation job within the shortest time of the first example is partitioned.

The installation sequence of the shortest time of the first example corresponds to No. 3 of FIG. 17. The installation sequence then is “G→H→A→C→E→D→B→F” (installation cost is 275).

If a conversion rate at which the installation cost is converted into real time is 2 minutes per cost 1, 4 hours of job time corresponds to an installation cost of 120. If the installation costs are summed from the first software in the No. 3 installation sequence candidate of FIG. 17, the installation cost of 120 is reached when the software E is installed.

In the sixth example, the installation job of “G→H→A→C” falls within 4 hours of job time. In the sixth example, an appropriate installation sequence of a plurality of pieces of software is selected within a specific time range.

If the installation job is partitioned by a time ratio during the installation of software in the sixth example, only the cost of a file size may be used as a measure according to which the installation time of each piece of software is estimated.

In the sixth example, the installation job may be divided in time taking into consideration installation time of each piece of software. By converting the installation cost into time, the installation job is thus partitioned in view of actual job operation time.

In the embodiment, an appropriate installation sequence of a plurality of pieces of software may be selected. The embodiment ensures software consistency among the pieces of software, and provides the shortest installation sequence meeting the user's request. The embodiment ensures an efficient installation job.

The embodiment causes the software to be installed in a consistent sequence and for the shortest period of time, thereby permitting an efficient job and controlling rework of the job. The embodiment allows the installation job to be performed in concert with procurement schedule of software, and wait time for job is reduced. The embodiment reorganizes the installation sequence in accordance with the difficulty level, thereby permitting appropriate manpower arrangement. The embodiment partitions the installation job in view of the job time, thereby permitting efficient job assignment.

The embodiment selects the installation sequence of a plurality of pieces of software from among sequence candidates that account for a plurality of factors affecting the entire job time. Time and labor involved in the installation job are thus reduced. The embodiment provides not only a mere time reduction but also a sequence selection that accounts for the specified installation sequence and the difficulty level. The installation process appropriate for a target apparatus is thus performed.

The examples have been described. The examples are not limited to any particular example. A variety of changes and modifications may be possible within the scope defined by the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An installation control method executed by a computer, the installation control method comprising:
extracting installation information related to an install process of each of a plurality of software modules to be installed onto an apparatus;
calculating a load with respect to the install process onto the apparatus, in installing the plurality of software modules in each of a plurality execution sequence candidates of an install process in accordance with the installation information; and
selecting an execution sequence that is executed by the apparatus, among the execution sequence candidates, in accordance with the load.

2. The installation control method according to claim 1, further comprising:
extracting a dependency relationship between the software modules in accordance with the installation information; and
extracting an execution sequence candidate among the plurality of execution sequence candidates in accordance with the dependency relationship,
wherein the load is calculated for the execution sequence candidate.

3. The installation control method according to claim 2, further comprising:
extracting a partial execution sequence that indicates a first software module is installed after installation of a second software module based on the dependency relationship,
wherein the execution sequence candidate is extracted in accordance with the partial execution sequence.

4. The installation control method according to claim 1, further comprising:
acquiring an installation condition specified by a user,
wherein the execution sequence is selected in accordance with the load and the installation condition.

5. The installation control method according claim 1, wherein the load is calculated in accordance with a condition that becomes a specific overhead.

6. The installation control method according to claim 5, wherein the installation condition is set up in accordance with at least one of a load of a file size of each of the software modules on the apparatus, a load of a restart of an operating system on the apparatus, a load of a startup of a service on the apparatus, and a load of an effect of the service in operation on the apparatus.

7. The installation control method according to claim 1, wherein the execution sequence is selected in accordance with a difficulty level of the install process of the software modules.

8. The installation control method according to claim 1, further comprising:
collecting past record data of at least part of the software modules from another apparatus on which the at least part of the software modules has been installed; and
generating the installation information using the past record data.

9. An installation control apparatus comprising:
a memory; and
a processor coupled to the memory and configured to:
extract installation information related to an install process of each of a plurality of software modules to be installed onto an apparatus,
calculate a load with respect to the install process onto the apparatus, in installing the plurality of software modules in each of a plurality execution sequence candidates of an install process in accordance with the installation information, and
select an execution sequence that is executed by the apparatus, among the execution sequence candidates, in accordance with the load.

10. The installation control apparatus according to claim 9,
wherein the processor is further configured to:
extract a dependency relationship between the software modules in accordance with the installation information, and
extract an execution sequence candidate among the plurality of execution sequence candidates in accordance with the dependency relationship, and
wherein the load is calculated for the execution sequence candidate.

11. The installation control apparatus according to claim 10,
wherein the processor is further configured to extract a partial execution sequence that indicates a first software module is installed after installation of a second software module based on the dependency relationship, and
wherein the execution sequence candidate is extracted in accordance with the partial execution sequence.

12. The installation control apparatus according to claim 9,
wherein the processor is further configured to acquire an installation condition specified by a user, and
wherein the execution sequence is selected in accordance with the load and the installation condition.

13. The installation control apparatus according to claim 9, wherein the load is calculated in accordance with a condition that becomes a specific overhead.

14. The installation control apparatus according to claim 13, wherein the installation condition is set up in accordance with at least one of a load of a file size of each of the software modules on the apparatus, a load of a restart of an operating system on the apparatus, a load of a startup of a service on the apparatus, and a load of an effect of the service in operation on the apparatus.

15. The installation control apparatus according to claim 9, wherein the execution sequence is selected in accordance with a difficulty level of the install process of the software modules.

16. The installation control apparatus according to claim 9, wherein the processor is further configured to:
collect past record data of at least part of the software modules from another apparatus on which the at least part of the software modules has been installed; and
generate the installation information using the past record data.

17. A non-transitory recording medium storing an installation control program that causes a computer to execute a procedure, the procedure comprising:
extracting installation information related to an install process of each of a plurality of software modules to be installed onto an apparatus;
calculating a load with respect to the install process onto the apparatus, in installing the plurality of software modules in each of a plurality execution sequence candidates of an install process in accordance with the installation information; and
selecting an execution sequence that is executed by the apparatus, among the execution sequence candidates, in accordance with the load.
